(19) United States
(12) Patent Application Publication
(10) Pub. No.: US 2010/0012556 A1
(43) Pub. Date: Jan. 21, 2010

(54) ROTATING SCREEN MATERIAL SEPARATION SYSTEM AND METHOD

(76) Inventor: Daniel L. Pohle, Butlerville, IN (US)

Correspondence Address: BOSE MCKINNEY & EVANS LLP, 111 MONUMENT CIRCLE, SUITE 2700, INDIANAPOLIS, IN, 46204, US

(21) Appl. No.: 12/246,136

(22) Filed: Oct. 6, 2008

Related U.S. Application Data
(60) Provisional application No. 61/082,337, filed on Jul. 21, 2008.

(51) Int. Cl. B07B 1/22; B07B 13/16

(52) U.S. Cl. 209/240; 209/314; 209/270

(57) ABSTRACT

A material separation system for separating material into different sizes of material. The material separation system includes a support structure, a rotating screen, and a feed plate, to feed the material to the exterior of the rotating screen. The system can be used to separate a desired material from an aggregate material which includes the desired material.

### CROSS-REFERENCE TO RELATED APPLICATION

This application claims benefit of U.S. Provisional Patent Application Ser. No. 61/082,337, titled Rotating Screen Material Separation System and Method, to Pohle, the disclosure of which is expressly incorporated by reference herein.

### FIELD OF THE INVENTION

The present invention relates to a system and method for separating material of one material size from another material size and particularly to a system and method for separating material in the mining industry, particularly for the screening, washing and flow management of mine-run granular materials covering a large range of sizes and shapes processed wet or dry.

### BACKGROUND OF THE INVENTION

Precious gems, metals, minerals, and stones, including diamonds and gold, are typically mined by machines. Because most, if not all easily mined deposits of such precious materials have been located and depleted, most machinery used to mine precious materials is designed to separate these desired materials from undesired materials. In many instances, earthen material, typically rock, gravel or sand, is scooped up from the earth and placed in mining machinery which separates a target gravel from an undesired gravel. The target gravel is usually around thirty millimeters (mm) or less in size. This minus thirty mm gravel often must be washed to remove it from the larger material and to prevent the desired material from remaining in or clinging to crevices or cracks in the mining machinery. Otherwise this desired material can escape any later recovery process.

The screening and scrubbing takes place while starting a reasonable flow rate of the material either dry or in a wash, often called a slurry. Oftentimes it is necessary to spread the precious material bearing gravel into a thin wide slurry film for a later process of recovery of the precious material.

In known devices, the separation has been achieved by a vibrating or fixed screen device which is used to spread the gravel. In these types of devices, the granular materials tend to collect or to bind to the vibrating or fixed screen area especially when washing water is added. This stops or greatly interrupts the flow of desired material for use in later processes.

In addition, it has been found that the vibrating process used with many screens can be stopped very quickly when large boulders enter the mixture being separated.

Wet trommel screens are also used to remedy the clogging, while providing some sort of scrubbing action. Such trommel screens are very bulky and are highly subject to wear which can occur rather quickly over short periods of time. The wear factor as well as the size of the trommel screen required to effectively separate materials tends to make trommel screens expensive. Trommel screens rotate about an axis of rotation which is offset from horizontal. Material is placed inside the trommel screen at the higher end and travels towards a lower end. The trommel screen can be undesirable for many mining applications, because the material must be sorted to a size having a major diameter that can fit inside the trommel screen. Consequently, material to be separated must be pre-screened to fit inside the trommel screen. In some cases, more than one pre-screening step can be required. Such steps not only slow down the screening process but add to the expense of separation. Trommel screens also tend to prevent a spread of the slurry unless the material is pre-processed.

### SUMMARY OF THE INVENTION

The present invention responds to a need in the mining industry to screen granular desirable materials, including diamond and gold bearing material, from aggregate materials ranging in size from stones several meters in diameter to very fine sand.

The present invention can be built to withstand a heavy material weight as well as a large and heavy material flow while still screening the materials being classified down to a small finished size.

The present invention can process materials as either a wet or a dry aggregate material without interrupting the flow of material being processed. If the material is processed wet, the wet flow provides a washing and/or scrubbing action which can separate the materials being processed such that more of the desirable materials can be recovered.

The present invention includes a rotating screen have a rotational speed which can be adjustable to regulate the flow of material being processed.

The present invention includes a configuration which can distribute material onto a conveyor or to a down stream process.

In some embodiments, the present invention can include a single moving part to provide for the separation of material.

The rotating screen separation system can include three important components: 1) a rotating screen unit; 2) a feed plate; and 3) a discharge plate. The rotating screen unit can be marketed and sold individually.

The rotating screen begins separation of aggregate material according to size and/or shape when the material is dumped onto the sloped feed plate. Material slides down the feed plate which can be either fixed, vibrating, or a combination of the two. The selected angle of the feed plate can affect the feed rate of the material to the rotating screen. Water can be added to material located on the feed plate for washing and downstream separation processes.

Aggregate material sliding down the feed plate reaches and comes into contact with the external surface of the rotating screen. The material stops sliding at the external surface of rotating screen where some of the material is lifted and is carried by the apertured exterior surface of the screen. Some material falls through the apertures or openings. At this point, the separation of the aggregate material into groups of material according to size and/or shape takes place. Material having a size less than the apertures passes through the screen under the force of gravity, while material larger than the apertures, and often very large material, is carried by the screen as it rotates. Once the material is carried by the exterior portions of the rotating screen past its highest point, the oversized or undesired material is disposed of as necessary. By continuous rotation of the rotating screen, material can be continuously processed.

Washing of the material being processed can occur while the material moves down the feed plate by placing spray bars over an area toward or at the end of the feed plate. The spray bars can be located prior to and/or above the rotating screen. The spray bars typically spray water. Rotation of the screen provides for some displacement of the material along the length of the rotating screen, thereby spreading the material and exposing the material to the spray. Eventually, more material sliding down the feed plate helps the rotating screen lift this now clean material up and with the rotating screen as it rotates.

The oversize material which is carried by the exterior of the rotating screen and carried over the rotating screen may drop on a belt, chute, or simply hit a discharge plate to fall clear of the machine.

Some material even though sprayed with water, such as rock, stones, gems, and minerals, does not absorb water and can include what is called “dry target size material”. This material passes through the outer surface of the rotating screen and into the interior of the screen. This material then moves through the interior of the rotating screen and passes from the interior at the bottom of the rotating screen to the exterior. This material if dry can be allowed to fall in a pile to be scooped up with a piece of equipment, to fall on a conveyor to be carried to a pile, or to another process for further processing.

Material sprayed with water can form a slurry and can include what is called “wet target size materials”. The wet target size material and the added water can pass through the rotating screen twice, once from the exterior to the interior and once from the interior to the exterior. This flow of slurry can then be directed to another process where extraction of desired materials can be substantially completed.

### BRIEF DESCRIPTION OF THE DRAWINGS

FIG. 1 illustrates a perspective view of a rotating screen material separation system of the present invention.

FIG. 2 illustrates a front end perspective view of a portion of the separation system of FIG. 1.

FIG. 3 illustrates an elevational side exterior view of the material separation system of the present invention.

FIG. 4 illustrates a longitudinal cross sectional schematic view of the present invention of FIG. 3 along a longitudinal centerline.

FIG. 5 illustrates a perspective view of portion of a slurry receiving area of FIG. 4.

FIG. 6 illustrates a top view of the separation system of FIG. 1.

FIG. 7 illustrates a partial top view of the separation system of FIG. 1 illustrating a feed plate, a rotating screen, and the distance therebetween.

FIG. 8 illustrates a rear elevational view of the separation system of FIG.1.

FIG. 9 illustrates a perspective view of another embodiment of the present invention.

FIG. 10 illustrates an exploded perspective view of a rotating screen assembly.

FIGS. 11-15 illustrate different screen patterns of the present invention but are not limited thereto.

FIG. 16 illustrates a perspective view of another embodiment of a rotating screen assembly.

FIG. 17 illustrates a schematic elevated view of one embodiment of different discs used in a rotating screen assembly to allow for moving bars that help prevent clogging of the bar screen surface.

FIG. 18 illustrates a schematic elevated view of another embodiment of a disc used in a rotating screen assembly to allow for moving bars that help prevent clogging of the bar screen surface.

FIG. 19 illustrates a perspective view of a rotating screen assembly supported by a frame.

FIG. 20 illustrates another embodiment of a feed plate for use with a rotating screen assembly of the present invention.

### DETAILED DESCRIPTION OF THE DRAWINGS

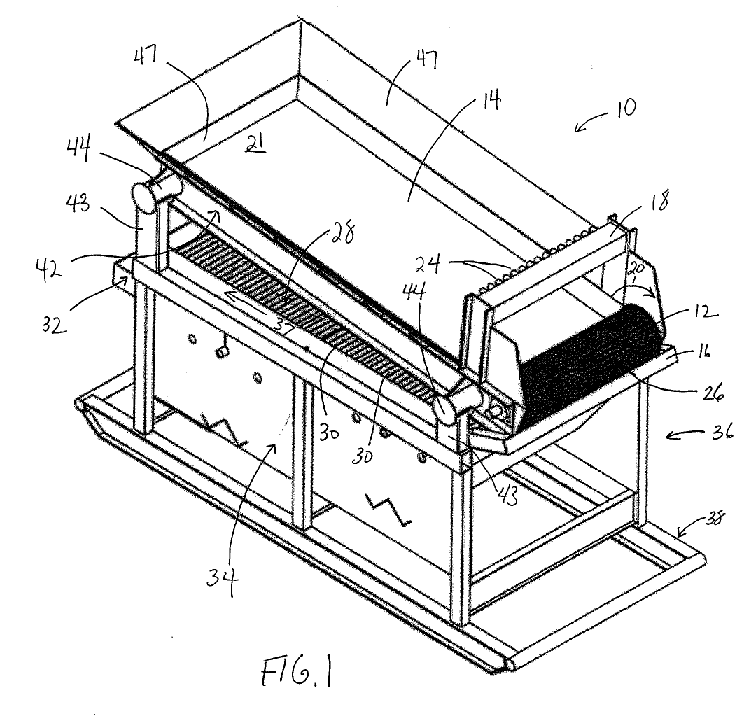

FIG. 1 illustrates a perspective view of a material separation system 10 of the present invention. The material separation system 10 includes a rotating screen 12, a feed plate 14, a discharge plate 16, and a spray bar 18. The rotating screen 12 rotates in a clockwise direction 20, as illustrated. A motor (not shown) rotates the screen. Gravel, or other material to be separated, is placed on the feed plate 14 towards an end 21 such that it moves down under the force of gravity and along the feed plate 14 which is inclined at an angle with respect to horizontal. The material flowing down the feed plate 14 moves into contact with the rotating screen 12.

The feed plate 14 is a plate type surface on the infeed side of the rotating screen on which material is placed to introduce it to the exterior rotating screen surface. The feed plate can be flat or curved and mounted at several angles and heights to adjust for material types and flow rates. Adjustments of feed plate configuration may also be needed if material is run wet to develop a slurry.

The feed plate 14 can be made of many different materials including but not limited to steel, rubber, plastic or wood with an abrasive resistant steel plate often being preferred. The placement of the feed plate enables the rotating screen to contain material to be screened and move it through the mechanisms to establish a flow to down stream processes. The feed plate can be fixed or can be moved with vibration or other mechanical methods. The feed plate can be the width of the rotating screen but the other dimensions of the feed plate can be selected according to the type of material and the method used for introducing the material to the feed plate.

The rotating screen 12 includes a plurality of apertures or holes, to be described in more detail later. As the material flows down the feed plate 14, the material contacts the rotating screen. As the screen rotates in the clockwise direction 20 (away from the flow direction of the material), material that is too large to enter the apertures of the rotating screen 12 is carried along or forced about the exterior surface of the rotating screen and falls past the discharge plate 16. The discharge plate 16 is angled with respect to horizontal to enable gravity to affect the material passing through the interior rotating screen 12 to thereby be captured for further processing.

It is also possible to wet the material which is flowing down the feed plate 14 with a spray bar 18. The spray bar 18, coupled to a supply of water (not shown), includes a plurality of nozzles 24 which spray water onto the material being processed and carried down the feed plate 14.

The rotating screen 12 includes an exterior surface 26 which contacts and receives the material flowing down the feed plate 14. Material which is larger than the apertures of the rotating screen 12 is carried along the outer surface and discharged. Material having a size smaller than the apertures of the rotating screen can pass through the apertures and into an interior of the rotating screen. Once the material passes through the rotating screen and into the interior thereof, the material can be processed a second time where further separation of material can occur. Material can then flow out through the apertures. The slurry flows into a receiving area 28. The slurry then passes over a number of ridges 30 which help to separate material having a greater specific gravity from the other undesired materials being processed. Consequently, the desired materials are captured in between the ridges 30 and remain there for later processing. The other material, which is lighter, passes over the top of the ridges and out a back portion 32 of the system.

A lower portion 34 of the system 10 can include additional spraying apparatus to maintain the material as a slurry in the area 28 as it flows along the direction 37. The system includes a supporting frame 36 which is used to support the washing apparatus 34, the wash area 28, the rotating screen 12, the feed plate 14, and the discharge plate 16. The frame 36 includes a sled 38 having horizontal lengthwise pieces and crosswise pieces such that the sled can be moved or dragged to a location. Wheels attached to the frame can also be used. The angle of the feed plate 14 can also be adjusted by elevating one end of the support structure with respect to the other end. Mechanically or electrically adjustable feed plates can also be included.

In one example, the feed plate 14 can include upstanding sides large enough to enable a five (5) cubic yard end loader to dump a load without waiting for the prior load to be completely processed. The rotating screen can be sized to contain the amount of material being processed. The rotating screen constantly lifts the oversize throughout the screening process while it enables the undersize material to pass through the interior of the rotating screen and out through the bottom portion of the screen as it rotates. The material passing through the bottom of the rotating screen can be gathered from a pile formed beneath the screen or can be deposited on a running belt located beneath the screen.

In one variation of the present invention for use in precious mineral mining, including diamond mining, bucket loads of precious mineral bearing material can be placed on a feed plate that is configured as a hopper. The feed plate-hopper is sloped with respect to horizontal toward the rotating portion of the rotating screen and is powered with a slight vibration. Water is added to form a slurry at this time. A spray of water from overhead is directed at the point where the material is being lifted up and over a twelve millimeter rotating screen section where twelve mm is the largest dimension of a hole or aperture in the rotating screen. The spray washes clays and other binding materials from the precious minerals which can hamper their recovery in the later recovery processes. The rotating screen assembly with a plurality of discs having a preselected diameter, a preselected number of twelve mm holes in the screen section, and rotating at a number of preselected revolutions per minute, forms a pool of material under the spray. In this pool, the precious minerals get washed and the bulk material is held back as needed while being spread the full width of the rotating screen. All of this provides the flow of a twelve mm or less slurry that spreads to substantially the full width of the rotating screen. The selection of these features provides the substantially correct slurry consistency and the substantially correct volume for the recovery of precious minerals including diamonds. The oversize waste material which can vary from thirteen mm to a meter or more in diameter passes over the rotating screen while being dewatered drops onto a belt or pile below.

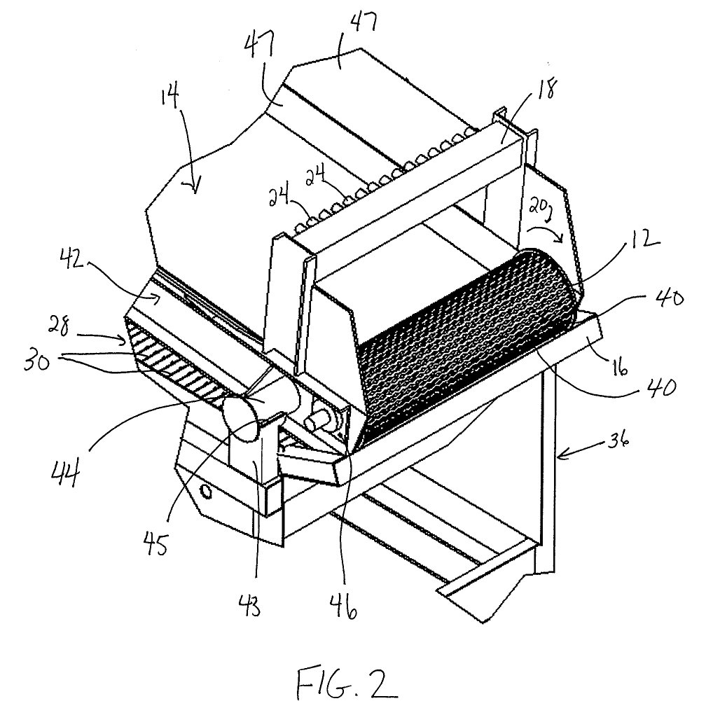

FIG. 2 illustrates a partial perspective view of a front portion of the separation system illustrated in FIG. 1. FIG. 2 illustrates in more detail the rotating screen 12 rotating in the clockwise direction 20. As can be seen, the rotating screen 12 includes a plurality of apertures 40, each of which includes a predetermined size selected to separate larger material from smaller material such that the desirable materials can be captured in the lower area 28.

FIG. 2 also illustrates a portion of a support structure 42 which supports the feed plate 14, the spray bar 18, nozzles 24, and rotating screen 26. (See FIG. 1) The support structure 42 is supported by vertical upstanding support beams 43 having a concave surface to receive support arms 44 of the support structure 42. Disposed between each of the support arms 44 and respective upstanding beams 43 is a separator 45 which conforms to the curved interface between the support beams 43 and the cylindrical support arms 44. Typically the separator 45 includes a rubber or other elastic and/or resilient material which can be either a natural or synthetic material.

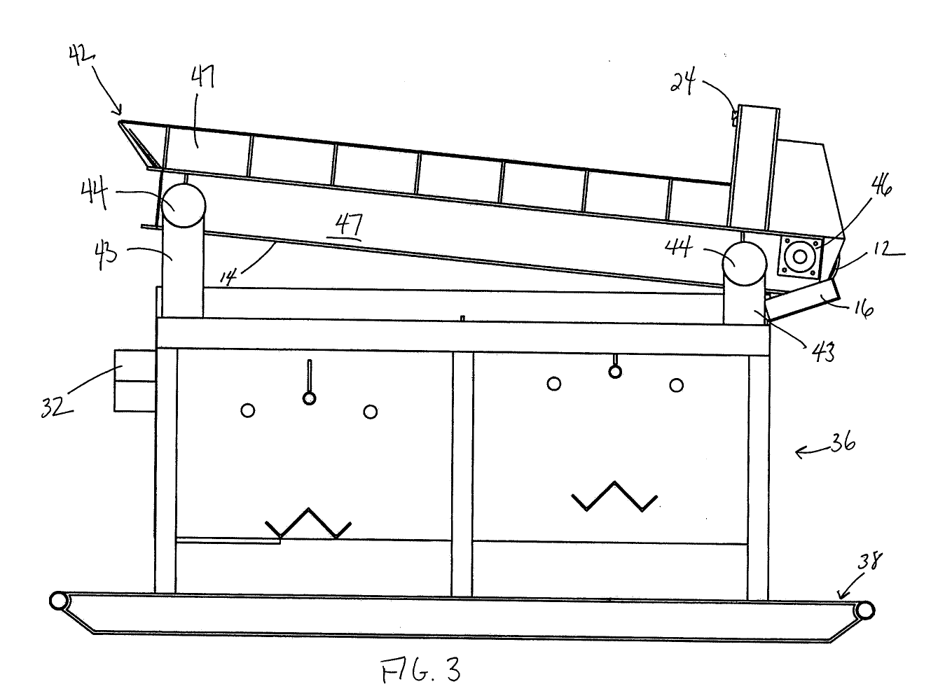

As can be seen in FIG. 3, the support structure 42 is angled with respect to horizontal. The feed plate has an incline to enable material, which is dropped onto the feed plate from an external dumping device to move and flow down the slope under the force of gravity. The support structure 42 is supported by the support structure 36 as previously described. The rotating screen 12 is supported for rotation at a support bearing 46. It is preferred that the long axis of the rotating screen be positioned horizontally such that the material being processed spreads along at least a substantial portion of the length of the screen. The support structure includes sidewalls 47 disposed either vertically or angled from vertical to maintain the material on the feed plate 14 as it moves down the plate toward the rotating screen 12.

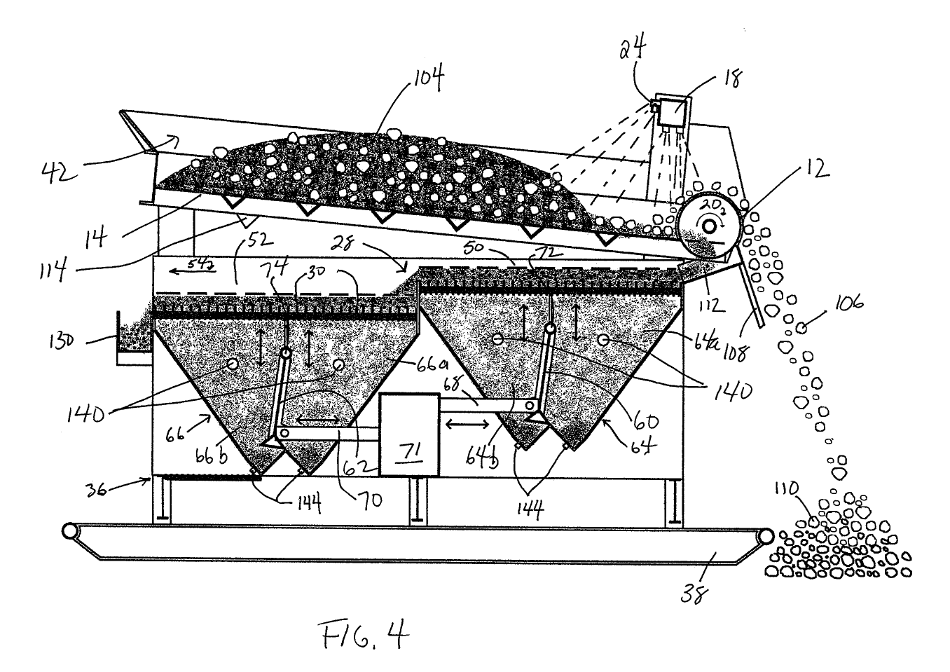

FIG. 4 illustrates a longitudinal cross sectional schematic view of the separation system of FIG. 3 which illustrates the feed plate support structure 42, the feed plate 14, the rotating screen 12, and the spray bar 18 having nozzles 24. The slurry receiving area 28 includes a first section 50 which is located at a higher elevation than a second section 52. As material is captured by the rotating screen 12 and passes through the screen to discharge plate 16, it lands upon and flows over the ridges 30. A two millimeter screen is located at the base of the ridges 30 which allows water to rise and fall at about one-hundred twenty cycles per minute. Water for the tub areas 64 and 66 is provided via openings 140. Swinging baffles 60 and 62 are driven fore and aft approximately two inches at the above mentioned rate of one-hundred twenty cycles per minute by actuator arms 68 and 70 driven by a gearbox 71. Other cycles per minute are within the scope of the present invention. The larger material which is carried by the slurry passes over the top ridges in the direction 54 where it passes over the end of the first section 50 and onto the second section 52 where further processing of the material occurs. The material which is captured by the ridges 30 includes material which has a heavier specific gravity than the other material passing over the top of the ridges. The swinging baffles 60 and 62 move about a top pivot axis 72 and 74 respectively. All previous mineral jig recovery systems use a complicated diaphragm system in this area which is subject to extensive wear.

The support structure 36 including the base 38 is made of an I-beam skid frame and several pieces of vertical box tubing supporting a four cell balanced wet jig mineral sorting plant. A tub area 64 includes a first cell 64a and a second cell 64b. A tub area 66 includes a first cell 66a and a second cell 66b. The entire upper unit 42 can rest or sit on top of the upstanding support beams 43 of the base 36 and does not require connectors to hold the two together. The upper unit 42 is a vibrating hopper-feeder-screening assembly that effectively washes and removes over target size material via the spray bars 18 and the rotating screen 12. The target size material is defined by the apertures of the rotating screen 12 as previously described. The upper unit 42 also prepares the clean target size material into a slurry and spreads it the full width of the feed plate 14 for introduction to the recovery system which includes the various elements supported by the support structure 36.

Material 104 is placed on the feedplate 14 for processing. The material 104 is typically “bank run” material including alluvial gravel containing targeted materials. Other materials, such as “pit run” materials can also be processed. The targeted materials can include minerals, gemstones, precious metals and other desirable materials as would be understood by one skilled in the art. To process the bank run material properly, the material should have or should be conditioned to have a viscous consistency. The conditioned material can be considered to be a “slimy” liquid material and can include all shapes and sizes of stones, including those that can weigh thousands of pounds.

As shown in FIG. 4, the rotating screen material separator (system and method) 10 conditions the various sizes and shapes of material 104 by the application of water by the spray nozzles 24 located along a spray bar. One or more rows of spray nozzles can be used. Because the material 104 has been wetted by the spray nozzles 24, the material separator 12 due to the size of the apertures, can typically process the material 104 without clogging or breaking during the process. The rotating screen separator 12 can be built sturdily enough to take the abuse of constant use throughout a twenty-four hour workday or as necessary while providing various materials at the target size for downstream mineral recovery. In one example, the openings of the rotating screen can often be approximately one inch when processing the material 104 to capture target size material including diamonds and/or gold in areas yielding a significant percentage in the desired material.

As the rotating screen 12 moves in the clockwise direction, substantially clean oversize material 106 falls from the rotating screen and onto an exit plate 108. The oversize material 106 collects in a pile 110 either on the ground as illustrated or in a collection container which can include the bed of a truck.

The target size material 112 passes through the rotating screen while being washed with the high pressure spray nozzles 24 mounted along the full width of the spray bar or water pressure manifold 18. This large water pressure manifold can be located so that a large number of spray nozzles 24 located thereon can wet and/or wash the bank run material moving down the feed plate 14 with the assistance of a powered vibrator 114. The powered vibrator can include a shaft between bearings that has another shaft wielded to the side of that shaft making it severely out of balance. When the out of balance shaft is rotated, via an electric or hydraulic motor, it can creates a right to left action (as seen in FIG. 4) helping to dislodge material 104 that may not want to flow downhill on the feed plate 14. The shock of this vibration is absorbed by the rubber bushing 45 that rests between beam 43 and arm 44. The powered vibrator can include any number of known vibrating devices which have eccentric mechanisms for providing a vibration across the feed plate 14. In some instances, the oversize material 106 can build up just before the rotating screen 12. This material can rotate in a counterclockwise direction or against the flow of material moving down the feed plate 14. This movement cleans the oversized material of materials or other minerals clinging to pieces making up the material. The water, the target size material, and material cleaned from the oversize material passes through the exterior surface of the rotating screen 12 to the interior of the rotating screen. It then passes from the inside of the rotating screen and out through the lower portions of the rotating screen on to other processes.

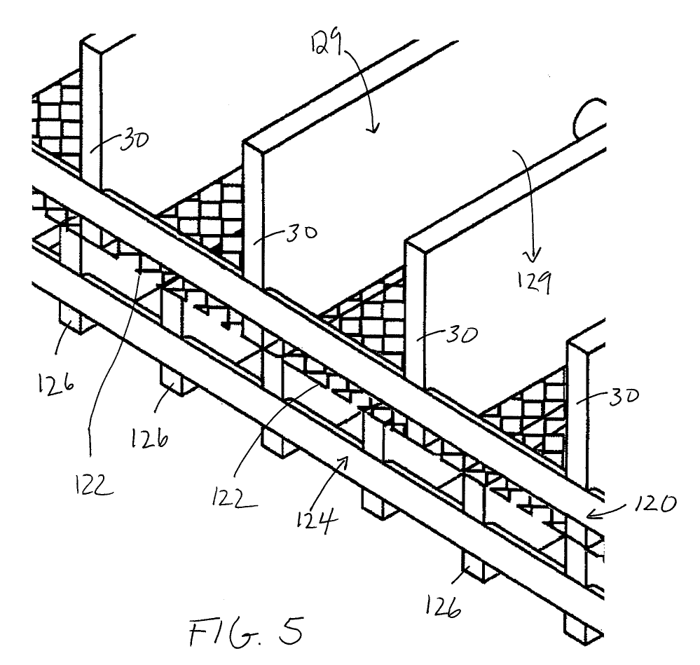

As the target size material passes from the interior of the rotating screen to the exterior of the rotating screen, it drops onto the discharge plate 16. The discharge plate 16 is angled with respect horizontal such that this target size material flows down and into the slurry receiving area 28, also described as a “separation bed.” The slurry receiving area 28 includes the first section 50 and the second section 52. (A portion of the slurry receiving area is shown in FIG. 5). The ridges 30 as previously described, include a series of upstanding vertical partitions which can be spaced from each other a predetermined distance. The spacing between adjacent ridges 30 can be approximately two inches and the height can be two inches because these materials can be readily obtained. For different mineral applications, however, these dimensions can vary just as the openings of the jig bed screen 122 can. Each of these ridges 30 comprise an essentially vertically upstanding divider which can be made of metal bar material or of box tubing, for instance having a desired thickness. The partitions 30 are held in an upstanding fashion by a support structure 120 which includes a longitudinally extending piece of metal bar to maintain the partitions in the predetermined and upstanding position.

Located beneath the partitions 30 is a jig bed screen 122. The jig bed screen 122 in the described embodiment includes a plurality of apertures which can be approximately two millimeters at its largest size which is particularly useful when the target material includes diamonds. The jig bed screen material is typically a stainless material, such as stainless steel, and is supported by a bar grate 124 including upstanding support structures 126 spaced apart and held in position by a longitudinally extending support 124. The support structures 126 can be offset or staggered from the partitions 30 located above to provide support for the screen 122 The partitions 30 located above the screen 122 create a plurality of longitudinally extending compartments 129 between partitions. The compartments 129 trap materials which pass over the top of each of the ridges or partitions 30 which settle to the surface of the screen. Material which is too large to pass through the apertures of the screen remains on top of the screen while the smaller material passes through the screen to the tubs 64 and 66 below.

As the slurry passes from the first section 50 to the second section 52, it moves to a discharge container 130 which carries away non-mineral bearing slurry of one inch material. This size is an example of a maximum target size material to pass through the screen 12. Any light weight untrapped target sized and smaller material can discharge as 130 via the discharge chute 32. Openings in the screen 12 other than one inch can be used. Most of the lighter material which is less than two millimeters in size is also discharged at the discharge container 130.

The first tub 64 and a second tub 66 are located below the first jig bed 50 and the second jig bed 52 respectively. Each of the tubs 64 and 66 includes a width which is essentially the same as the lateral width of the screen 122. In the described embodiment, the screen 122 is substantially the same width as the feed plate 14. As illustrated, each of the tubs 64 and 66 include a length which is approximately half the length of the horizontal travel distance of the feed plate 14.

The tub 64 includes a first cell 64a and a second cell 64b and the tub 66 includes a first cell 66a and 66b. Each of the cells include side apertures 140 which extend through a sidewall of the tub, one for each of the cells, such that water can be supplied to the cells through the apertures from an external supply (not shown). A sufficient amount of water is introduced through the apertures 140 to constantly charge each of the cells with water to an overflowing capacity and to at least partially submerge the screens 122 located above. The overflowing capacity causes the water to rise above the level of the screens 122 to further liquify the slurry flowing down the chute 16 and into the first and second portions 50 and 52. The water can be introduced to the cells via apertures 140 either under pressure from a pump or by gravity.

Each of the tubs 64 and 66 include the swinging baffles 60 and 62 respectively. The swinging baffles can include two arms which hang from a pivot bar located at a pivot point. The baffles divide the first cell from the second cell in each of the tubs. The pivot point is located a predetermined distance from the bottom of the screens such that the forward and backward moving distance of the swinging baffles can be selected.

The swinging baffles, or center dividers, swing from the pivot point in response to the actuating lever 68 and the actuating lever 70 driven by the gear box 71. The gear box 71 includes a motor and related gearing as would be understood by one skilled in the art. As can be seen, each of the swinging baffles includes a triangular shaped portion located at the end of the baffle opposite the pivot point to help agitate the water. The baffles substantially extend the width of the tubs to move and displace the water within the cells. At a lower most portion of each cell, a number of ports 144 provide attachment for hoses or other devices to carry the less than two millimeter heavy material to further recovery processes. While the ports can be threaded to allow attachment of hoses having connections, it is also possible to use containers below each of the ports to catch any of the material which falls from or exits the individual ports 144.

In operation, the present system can be powered by a number of sources including electric, pneumatic, and hydraulic. Several parts of the entire system which can be in motion include the uppermost unit 42 which is vibrated in response to the vibrating unit 114. The rotating screen 12 can rotate clockwise from approximately ten to forty revolutions per minute. The gear box 71 can operate from approximately eighty to one-hundred forty strokes per minute causing a reciprocating motion of the actuator arms 68 and 70 which in turn moves or swings the tub separation baffles front to rear approximately two to three inches. The stroke length can be determined either in the gearbox or at the point of attachment to the baffle to effectively shorten or lengthen the length of the arms 68 and 70. Adjustment can be made according to the type of materials being processed and minerals or materials being sought.

A constant flow of water is added to the materials 104 via the manifold 18 on top of the vibrating hopper/feeder/screening assembly and through the side ports 140 located on each of the tub cells 64a, 64b, 66a and 66b. A sufficient volume of water is forced into the tub cells to exceed the amount of water leaving each of the cells through the fine material discharge ports 144. Due to the action of the baffles 60 and 62, the water in the tubs moves up and down through the jig bed screen approximately one and one-half (1½) inches with each cycle of the swinging baffles. Due to this wave action formed by the swinging baffles, the water in the jig bed can be very active.

Placing a gravel based material 104 onto the rotating screen material separation system exposes that material to the vibrations made by vibrator 114 as well as to the washing water to the point that the material 104 moves down the slope on the feed plate to the rotating screen 12. During this time, the material will be exposed to the washing action of the water plus the tumbling action provided by the rotating screen. Small target size material forms a slurry and passes through the rotating screen while the oversize clean material rides or is carried by the exterior of the rotating screen out and onto the discharge plate to the discarded. The slurry materials which move through the rotating screen have only one option and that is to flow to the screen located above the top of the cells with the pulsating water bed.

As the water/gravel slurry travels over the cells, lighter material having a lower weight such as sand and small stones of about 2.0 specific gravity, simply stay in suspension and discharge through the system and out the slurry exit 130. Heavy materials that have a higher specific gravity such as a diamonds at 3.52 and gold at 17.0 are, due to their weight, do not move at the rate of the flowing slurry but slow down and drop out of suspension.

The heavy materials drop out of suspension based on size and weight. The larger pieces can be trapped on top of the jig bed screen while the particles small enough to pass through the screens fall in and through the tub water and flow out the system via the ports 144. The materials passing through the ports 144 can be processed more thoroughly by another device or can be selected through a hand operation. In addition, the larger pieces of minerals can be vacuumed from the cells as desired, such as a couple of times each shift, depending on the quality and quantity of minerals at the work site. Other minerals can also remain on top of the jig screen and these can be vacuumed out in an attempt to recover as much of the precious metals, gems, and minerals as desired.

Other later embodiments need to be described including the large rotating screen assembly having the floating bars which move according to gravity based on the slanted holding patterns formed in the discs.

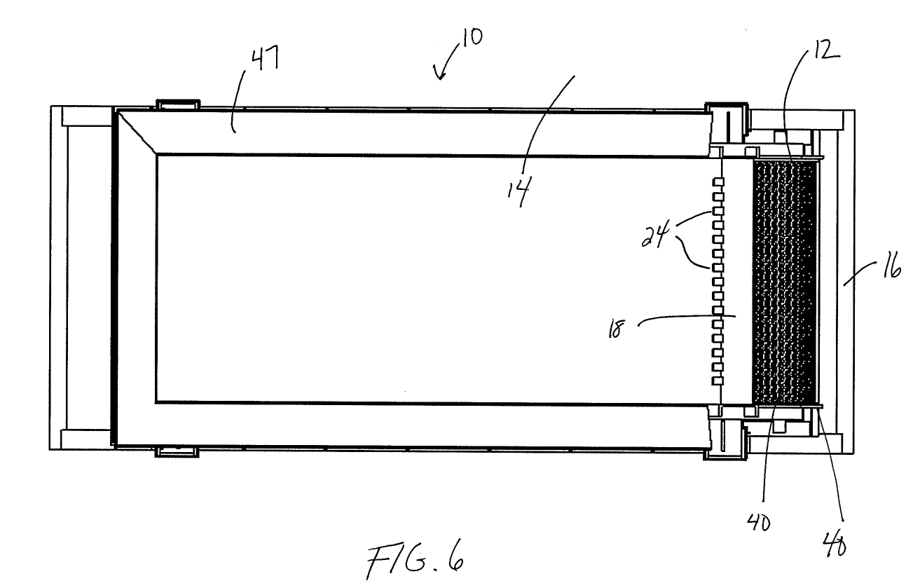

FIG. 6 illustrates a top view of the separation system 10 illustrating a top view of the feed plate 14, the rotating screen 12 and the spray bar 18. As material flows down the feed plate 14 it passes underneath the nozzles 24 where the material impacts the rotating screen 12.

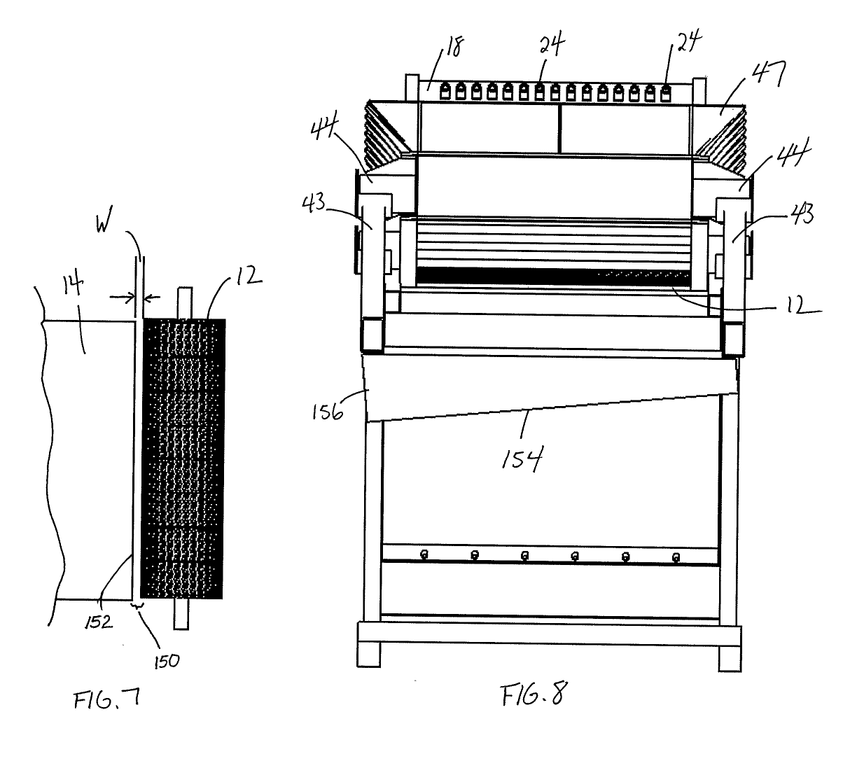

FIG. 7 illustrates a partial schematic view of the top of the material separation system 10 illustrating only the feed plate 14 and the rotating screen 12. As can be seen in this particular view, a gap 150 is located between an end 152 of the feed plate 14 and the exterior surface of the rotating screen 12. The gap 150 is typically selected to include a width “w” of approximately the same dimension as the size of the apertures of the rotating screen. Consequently, material which includes some dimension larger than the width of the gap 150 (depending on orientation) may not pass between the gap, but is instead carried up and over the top of the rotating screen and out the end of the separation system 10.

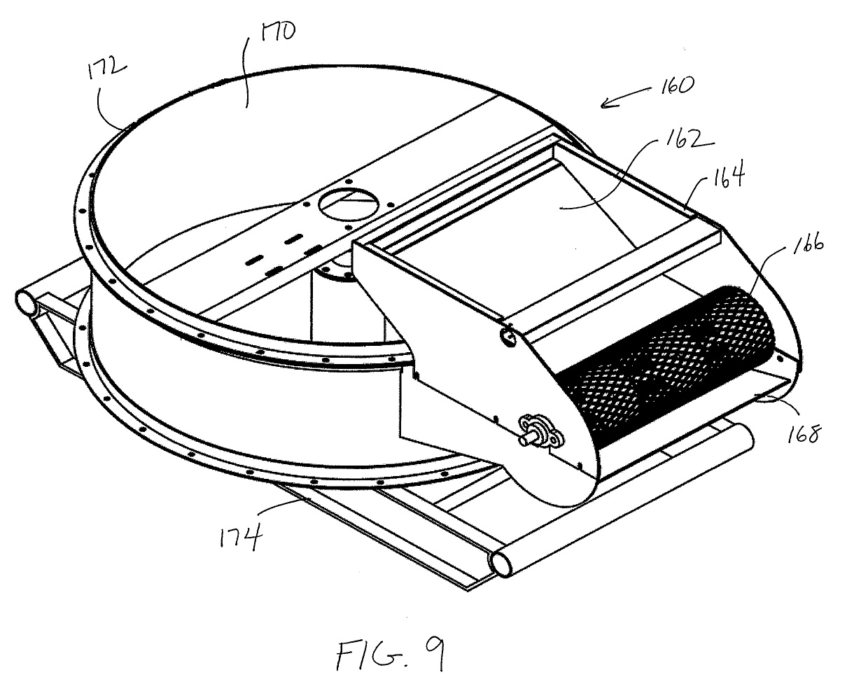

FIG. 8 illustrates a rear view of the material separation system 10 of the present invention having elements numbered as previously described. In particular, please note the discharge container 130 includes an angled or sloped bottom 154 for discharge of the slurry through an open end 156.

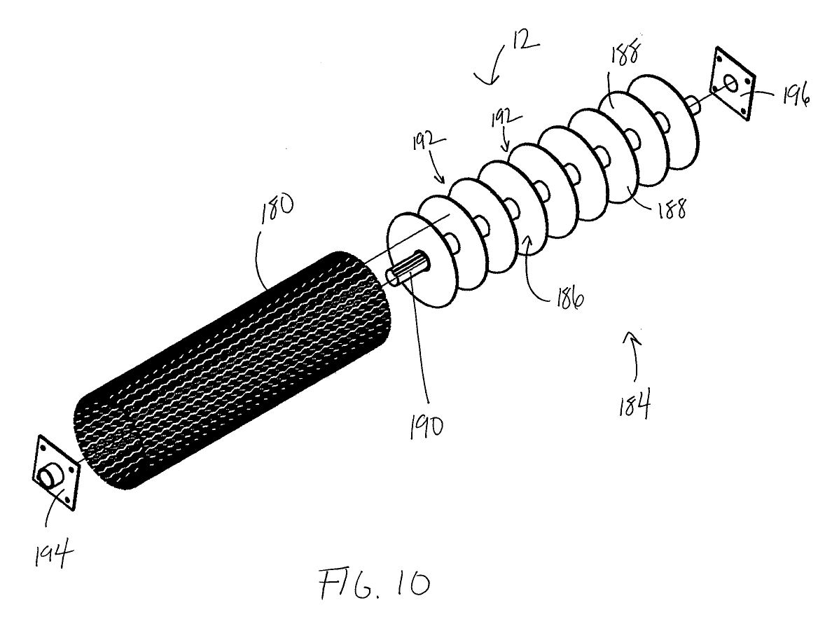

FIG. 9 illustrates another embodiment 160 of the present invention. In this embodiment 160, a feed plate 162 is held in place by a support structure 164 which not only supports the feed plate 162 but also a rotating screen 166. A discharge plate 168 having a function as previously described is located below the rotating screen and provides for transport of the separated material exiting the bottom portion of the rotating screen 166 into a circular chamber 170 defined by a cylindrical housing 172. A support structure 174 supports the cylindrical housing 172 which supports the feed plate 162, the support structure 164 and the rotating screen 166.

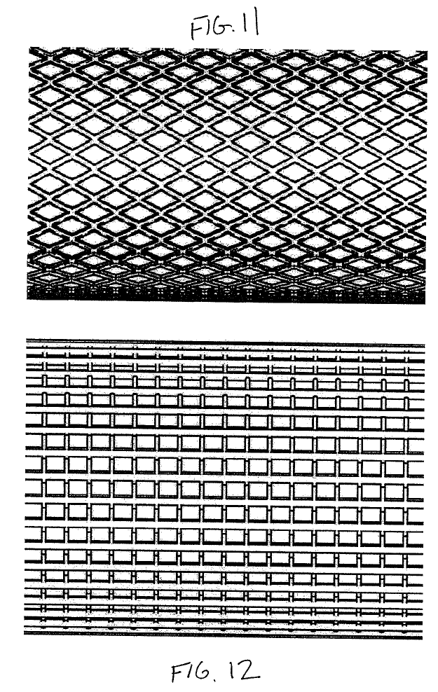

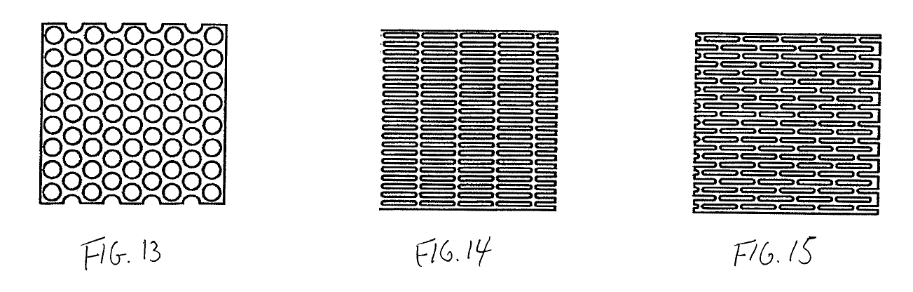

FIG. 10 illustrates one embodiment of a rotating screen assembly 12 of the present invention. The rotating screen 12 includes a screen 180 which is formed in the shape of a cylinder. The screen 180 can be made from any number of commercially available screens or can be custom designed to include apertures of a desired shape and size. Various examples of screens 180 having screen apertures 182 are illustrated in FIG. 11 (diamond), FIG. 12 (rectangle), FIG. 13 (circular), FIG. 14 (slots aligned) and FIG. 15 (slot non-aligned).

The shaped screen 180 includes a longitudinal axis which runs lengthwise down the center of the cylindrical screen into which a shaft assembly 184 is inserted. The shaft assembly 184 includes a support structure 186, such as plurality of discs 188 on a shaft 190. The discs 188 can be welded to the shaft 190. The discs provide support for the screen 180 as well as to separate the interior of the rotating screen into a number of compartments 192. The screen 180 can be tack welded to the discs 188. Other methods can also be used. While discs having a solid piece of metal plate, as shown, can be used, other support structures are within the scope of the present invention. For instance, spokes or perforated discs can also be used.

The discs 188 are typically circular and cut from metal plate to include a hole in the center having a size to match the outside dimension of the shaft 190. The outside dimension of the disc, typically a diameter, determines the outside diameter of the cylindrical rotating screen assembly. The number and spacing of discs can be selected based on strength requirements of the rotating screen assembly. The discs can be placed on the shaft and attached by a number of methods. The most common and simplest method of attaching the discs to the shaft is welding, but other methods may be used. The discs when placed on the shaft provide a base over which a screen is attached.

The screen 180 can be made from any type of screening material such as “screen door” screen material up to and including a number of heavy bars which are disposed horizontally as described later herein. Once the shaft assembly 184 has been inserted into the interior space defined by the screen 180, a first bearing plate 194 and a second bearing plate 196, each supporting bearings, capture the ends of the shaft 190 which supports the discs 188. The bearings support the assembly 186 for rotation of the entire rotating screen assembly 12. One such bearing plate is shown in FIG. 2 as element 4b.

The screen 180 can include any type of covering of the discs 188 that can lift and carry the over size material while having openings through which the undersize material can pass. The screen material can be as simple as a fine cloth with holes or as massive as large steel bars. A sheet metal with 12 mm holes punched in it or expanded metal can be used. Attachment of the screen to the discs can be accomplished in a number of ways, including welding.

The shaft can be selected to be strong enough to support the weight of the materials which pass over the screen and large enough to withstand the torque needed to rotate the screen assembly under the same load. The shaft also includes a length sufficiently long enough to pass through the screen assembly and the supporting bearings on both ends with enough protruding on one end on which to attach a drive mechanism. The shaft can be round, square or even hexagonal depending on the application.

In addition, the screen surface can be made up of large steel bars which fit loosely in slots located around the perimeter of the discs. These large steel bars can then easily be changed when damaged and can also provide a loose rattling effect helping to shake oversize from the openings on the downward stroke of the rotation.

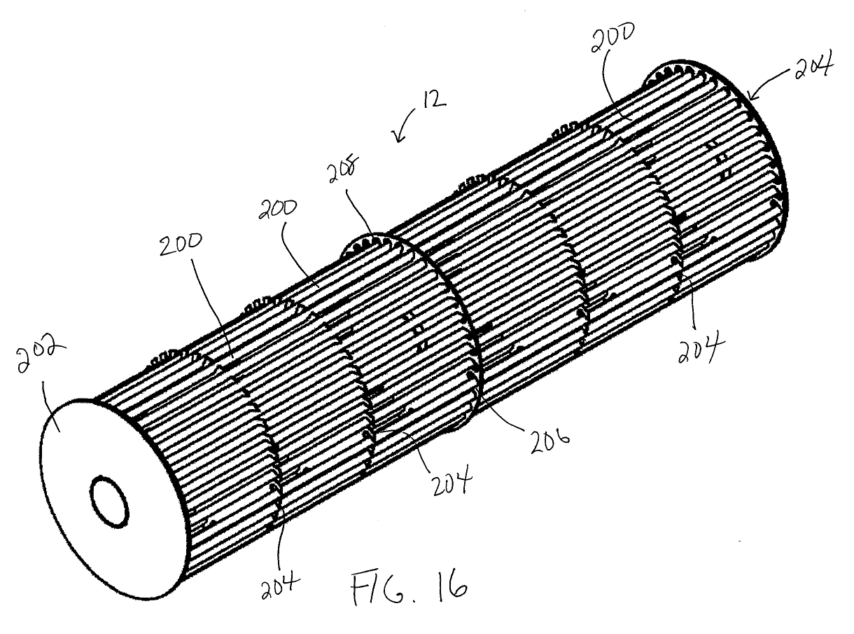

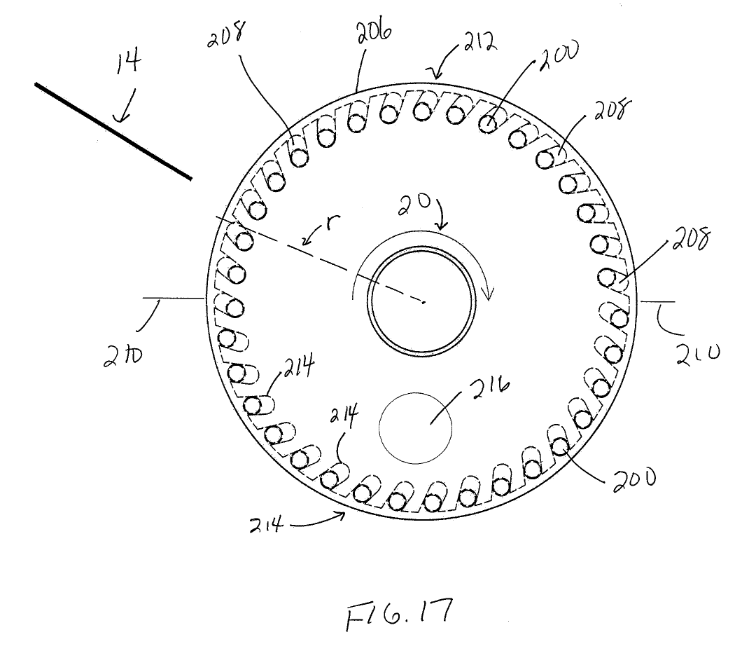

FIG. 16 illustrates a perspective view of another embodiment of a rotating screen assembly 12. In this embodiment, the rotating screen assembly 12 includes a plurality of bars 200 which extend the length of the rotating screen assembly. The extending bars 200 are supported by a first end disc assembly 202 and a second end disc assembly 204. Located between each of the end discs assemblies is a plurality of intermediate discs 204, each of which provides support for the bars 200. One of the included discs is a central disc 206 which includes a plurality of closed apertures 208 as further illustrated in FIG. 17.

Each of the closed apertures 208 is located about a periphery of the central disc 206. The closed apertures 208 define an aperture having a length which is greater than a width. The width is selected to be slightly larger than the same size as the outside dimension of the bars. As the rotating screen assembly 12 rotates in the direction 20, each of the bars 200 moves substantially freely within the aperture 208. The bars 200 are constrained by each of the closed apertures 208 but move under the force of gravity as the disc 206 rotates. (A horizontal line 210 indicates the horizontal position of the rotating screen assembly.) As the disc 206 rotates, the bars will move from a first end of the closed aperture 208 to a second end of the closed aperture 208 as illustrated. For instance, as can be seen at a top portion of the disc 212, the bars 200 are located substantially at one end of the closed aperture 208. As the disc 206 continues to rotate, the bars tend to move with the force of gravity and locate at an opposite end of the closed apertures 208 as illustrated at location 214. Consequently, the bars tend to move under the force of gravity from one end of the closed aperture to another end of the closed aperture and back again. The movement helps dislodge material which can become trapped between bars as well as to clean the material being processed.

FIG. 17 also illustrates a dotted outline of the intermediate disc 204. Each of the intermediate discs include a slot or an open ended aperture 214 which are substantially similar to the size and shape of the apertures 208 except that one end of the aperture towards the outer circumference of the disc is open. While the intermediate disc 204 does not require an open ended aperture as illustrated, it is desired to have an open ended aperture to ensure that the bars have a substantially unencumbered range of motion as the rotating screen assembly 12 rotates about the axis of rotation 20. FIG. 17 also illustrates another aspect of the present invention which includes an object 216 which can be placed within the assembly 12 to dislodge or to displace objects which can become trapped or caught between the bars 200. While the bars 200 tend to dislodge materials caught therebetween due to their movement during rotation of the screen, the object 216 can be placed within each of the compartments defined by adjacent discs 204 or 202 or 206. The object can include metal or rubber spheres or balls as well as other objects which can move within the compartments.

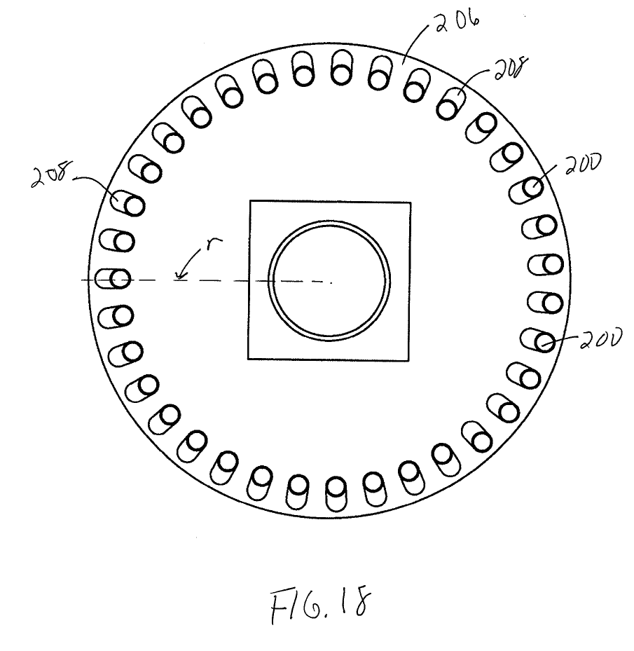

FIG. 17 illustrates that the long axis of the apertures 208 are offset with respect to a radius r defined by the circular discs 202, 204, 205, or 206. It is also within the scope of the present invention, as illustrated in FIG. 18 to include a disc 206 having the long axis of the apertures 208 aligned with the radius of the circle defined by the disc.

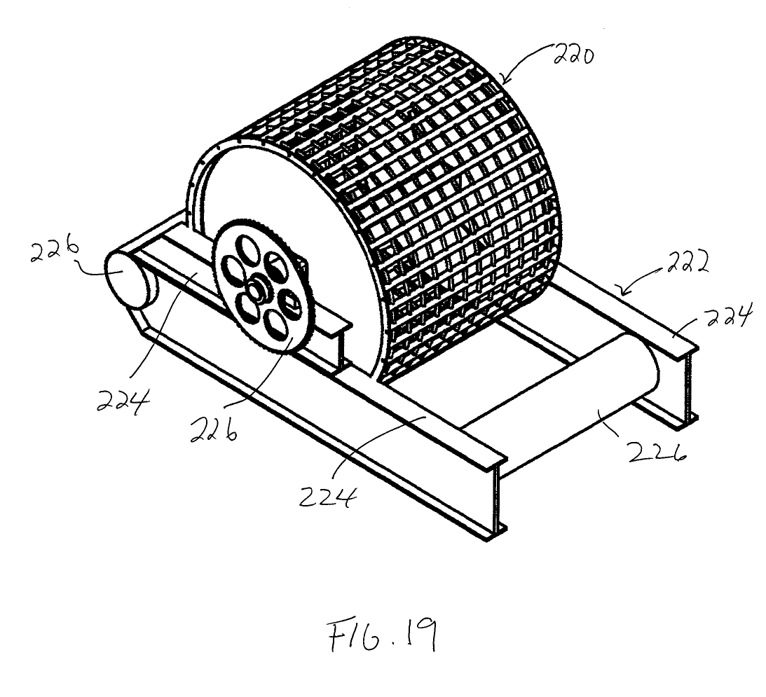

While the present invention can be used to mine precious gems, metals, minerals, and other materials, it is within the scope of the invention to provide a rotating screen device as illustrated in FIG. 19 for use in separating materials of different sizes such as from demolition sites. As illustrated in FIG. 19, a rotating screen assembly 220 is supported for rotational movement upon a frame 222 constructed of I-beams 224 and pipe 226. The rotating screen assembly 220 is supported upon one of the I-beams 224 for rotational movement and includes a gear 226 which can be coupled to a chain drive and motor (not shown).

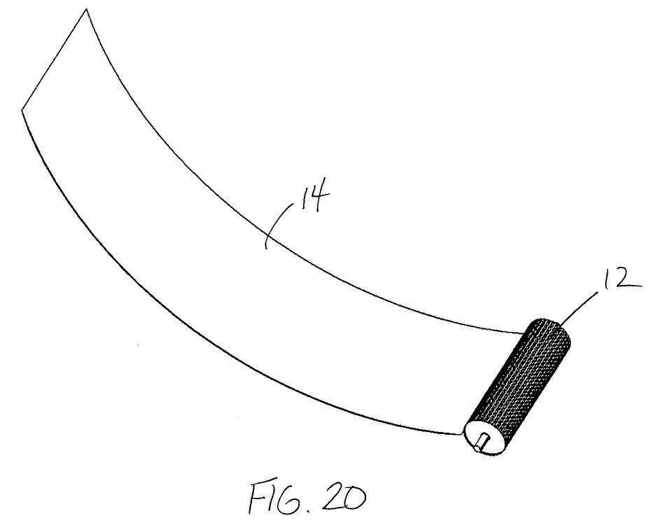

While exemplary embodiments incorporating the principles of the present invention have been disclosed hereinabove, the present invention is not limited to the disclosed embodiments. Instead, this application is intended to cover any variations, uses, or adaptations of the invention using its general principles. For instance, as illustrated in FIG. 20, the feed plate 14 does not need to be substantially planar but can be curved to create a partially concave surface as illustrated. A fixed curved feed plate 14 can help feed irregularly shaped material such as demolition material to the rotating screen separator 12 with as few parts as possible. Consequently, only the rotating screen separator needs would have to move thereby reducing the cost of construction. While aggregate materials including rocks, stones, minerals, gems, sand and other naturally occurring materials are described, the present invention is not limited to these type of materials. The present invention can also be used, for instance, to separate aggregate materials resulting from the demolition of buildings, roads, or other manmade structures and devices. In addition, the present invention can be used at outdoor shooting ranges to clean soil of shot, including waste bullets, shotgun shot, or pellets which can often be made of lead, copper, or other materials. If used for shooting range applications, the apertures of the rotating screen can be approximately one inch or smaller. The apertures of the screen 122 of the jig bed can be approximately one-eighth inch instead of two millimeters as previously described. This size can allow the shot to pass through the screen 122 and out the bottom of the jig cells to a secondary separator. As can be seen, the size of the openings can be selected according to the desired application. Rotational speeds of the rotating screen and water volumes in the tubs can also be selected according to the type of material being recovered. Further, this application is intended to cover such departures from the present disclosure as come within known or customary practice in the art to which this invention pertains and which fall within the limits of the appended claims.

What is claimed is:

1. A material separation system for separating aggregate material into groups of material characterized by differences in size, shape, or weight to provide for the recovery of a desired material from the aggregate material, comprising:
a rotating screen assembly, including a support structure and a screen shaped to define a substantially cylindrical structure having a plurality of apertures, an exterior surface, and an interior space, the rotating screen assembly coupled to and supported by the support structure for rotation about an axis of rotation; and
a feed plate disposed adjacent to the exterior surface of the rotating screen assembly to direct the aggregate material to the rotating screen assembly for separation of the aggregate material into groups of material, wherein one of the groups of material includes a desired material.

2. The material separation system of claim 1, wherein the each of the plurality of apertures include a dimension selected to pass material of a selected size though the exterior surface to the interior space.

3. The material separation system of claim 2, wherein the support structure comprises an axle, disposed within the substantially cylindrical structure and defining an axis of rotation and a support structure disposed along the axle to support the screen for rotation about the axis of rotation.

4. The material separation system of claim 3, wherein the support structure comprises a plurality of discs, each of the discs including an aperture sized to accept the axle, wherein each of the discs are coupled to the axle and are spaced from one another to define a chamber therebetween and to provide support for the screen.

5. The material separation system of claim 4, wherein each of the discs includes a substantially planar surface, to reduce the likelihood of the aggregate material moving from one chamber to the another chamber.

6. The material separation system of claim 4, wherein the screen comprises a plurality of longitudinally extending bars supported by the plurality of discs.

7. The material separation system of claim 6, wherein at least one of the discs defines a circle having a circumference and a plurality of apertures spaced away from the circumference, each of the apertures defining a substantially contiguous edge, wherein each of the bars passes through at least one of apertures.

8. The material separation system of claim 7, wherein at least one of the discs defines a circle and a plurality of slots disposed at the circumference, each of the slots defining a an open end, wherein each of the bars passes through at least one of the slots.

9. The material separation system of claim 8, wherein each of the plurality of apertures defines a length longer than a width, wherein the width is slightly larger than a cross-sectional dimension of each of the bars.

10. The material separation system of claim 9, wherein the length defines a path to direct movement of the bars, wherein the path is offset from a radius of the circle.

11. The material separation system of claim 9, wherein the length defines a path to direct movement of the bars, wherein the path is substantially aligned with a radius of the circle.

12. The material separation system of claim 10, further comprising a plurality of objects, at least one of the plurality of objects is disposed in each of the chambers.

13. The material separation system of claim 11, wherein each of the plurality of objects comprises a sphere.

14. The material separation system of claim 3, further comprising a frame, to support the feed plate and the rotating screen assembly, the feed plate having an end spaced a distance from the exterior surface of the screen and a plurality of spray nozzles disposed above the feed plate and rotating screen to provide water to the aggregate material directed to the exterior surface of the screen.

15. The material separation system of claim 14, further comprising a discharge plate disposed below the rotating screen assembly, and a separation bed located disposed adjacent the discharge plate, the separation bed including a plurality of ridges spaced from one another to define a plurality of chambers, and a second screen located beneath the plurality of ridges, the second screen being substantially planar between each of the plurality of ridges.

16. The material separation system of claim 15, further comprising a tub, disposed beneath the separation bed, a hanger, at least one baffle suspended from a hanger, and an actuating arm, coupled to the baffle to move the baffle in a first direction and a second direction.

17. The material separation system of claim 16, wherein the feed plate, the rotating screen assembly and the plurality of nozzles comprise a first unit, the first unit including a plurality of arms, and the separation bed and the tub comprise a second unit, the second unit including a plurality of upstanding supports, wherein the plurality of arms contact the plurality of upstanding supports and define an interface therebetween, wherein each of the interfaces includes a cushion.

18. The material separation system of claim 16, further comprising a vibrating device coupled to the first unit, to vibrate the first unit.

19. The material separation system of claim 16, wherein the apertures of the first mentioned screen include a dimension of approximately an inch or less, and the second screen includes apertures having a dimension of approximately an eighth of an inch or less, wherein the aggregate material includes at least soil and shot and the desired material includes shot.

20. The material separation system of claim 16, wherein the apertures of the first mentioned screen include a dimension of approximately an inch, and the second screen includes a dimension of approximately two millimeters, wherein the aggregate material includes at least soil and at least one of a precious metal and a precious stone and the desired material includes the at least one of precious metal and the precious stone.

21. A method for separating aggregate material into groups of material characterized by differences in size, shape, or weight to gather a desired material such as gems, metal, and stones, comprising:
providing a feed plate next to a screen assembly having a first screen with apertures, the screen shaped to define a substantially cylindrical structure having an exterior surface and an interior space;
placing the aggregate material onto the feed plate;
rotating the screen assembly about an axis of rotation;
collecting a first group of material from the aggregate material, the first group being characterized as including material of a first size, the first group being generated by contact with the exterior of the screen assembly;
collecting a second group of material from the aggregate material, the second group being characterized as including material of a second size, the second group being generated by contact with the exterior of the screen assembly and by moving through the apertures of the screen and through the interior of the cylindrical structure; and
moving the second group of material to a second screen; the second screen being substantially horizontal; and
moving water through the second group of material located on the second screen; and
collecting a third group of material which falls through the second screen, to gather the desired material.
